(19) United States
(12) Patent Application Publication
(10) Pub. No.: US 2019/0235824 A1
(43) Pub. Date: Aug. 1, 2019

(54) MOBILE SHOP SYSTEM, AND CONTROL METHOD OF MOBILE SHOP SYSTEM

(71) Applicant: Toyota Jidosha Kabushiki Kaisha, Toyota-shi Aichi-ken (JP)

(72) Inventors: Michio Ikeda, Nagoya-shi Aichi-ken (JP); Eiichi Ishii, Nisshin-shi Aichi-ken (JP); Mitsugu Makita, Nagoya-shi Aichi-ken (JP); Toru Yoshida, Miyoshi-shi Aichi-ken (JP); Gaku Itou, Nagoya-shi Aichi-ken (JP)

(21) Appl. No.: 16/260,532

(22) Filed: Jan. 29, 2019

(30) Foreign Application Priority Data
Jan. 30, 2018 (JP) 2018-013959

(51) Int. Cl. G06F 3/14; H04L 29/08

(52) U.S. Cl. CPC G06F 3/1454; H04L 67/12

(57) ABSTRACT

A mobile shop system includes a plurality of mobile shop vehicles and a server device, where the server device includes an instruction unit configured to transmit an image display instruction indicative of an image to be displayed on an outside display device, to the plurality of mobile shop vehicles, and each of the plurality of mobile shop vehicles includes the outside display device provided on an outside of a vehicle body, a receiver configured to receive the image display instruction from the server device, and a display controller configured to control display contents of the outside display device according to the image display instruction.

### CROSS-REFERENCE TO RELATED APPLICATION

This application claims the benefit of Japanese Patent Application No. 2018-13959, filed on Jan. 30, 2018, which is hereby incorporated by reference herein in its entirety.

### BACKGROUND

### Technical Field

The present disclosure relates to a mobile shop system including a plurality of mobile shop vehicles, and a control method of the mobile shop system.

### Description of the Related Art

There is a proposal to use vehicles as mobile shops and mobile exhibition venues (Patent document 1). It is conceivable to gather such mobile shop vehicles in an open space to build a shopping mall.

It is also conceivable to make an appearance of a vehicle body of a mobile shop vehicle changeable, by providing a display on a large part or all of an exterior of the vehicle body.

In a shopping mall made up of a plurality of mobile shop vehicles, if each mobile shop vehicle produces a different appearance, there is a problem that a sense of unity as one shopping mall cannot be achieved.

### CITATION LIST

Patent Literature 1: Japanese Patent Laid-Open No. 2010-143558

### SUMMARY

The present disclosure has been made in view of the problem described above, and has its object to maintain a sense of unity in terms of appearance of a shopping mall made up of a plurality of mobile shop vehicles.

A mobile shop system according to an aspect of the present disclosure may be a mobile shop system including a plurality of mobile shop vehicles and a server device. The server device according to the present aspect may include an instruction unit configured to transmit an image display instruction indicative of an image to be displayed on an outside display device, to the plurality of mobile shop vehicles. Each of the plurality of mobile shop vehicles according to the present aspect may include the outside display device provided on an outside of a vehicle body, a receiver configured to receive the image display instruction from the server device, and a display controller configured to control display contents of the outside display device according to the image display instruction.

According to such a configuration, the mobile shop system according to the present aspect may achieve an appearance with a sense of unity, based on an instruction from the server device.

In the present aspect, the each of the plurality of mobile shop vehicles may further include a storage configured to store image data in association with a display type that is determined in advance, the image display instruction may include the display type of an image to be displayed on the outside display device, and the display controller may be further configured to acquire, from the storage, the image data that is associated with the display type included in the image display instruction, and to perform display on the outside display device.

As described above, when image data according to a display type is stored in advance in the mobile shop vehicle, an image display instruction including the display type but without image data can be used, so that the amount of data communication may be reduced. Because each mobile shop vehicle separately stores image data, different images may be displayed on the outside display devices.

To achieve a sense of unity in terms of the appearances of the plurality of mobile shop vehicles, a predetermined criterion is desirably provided with respect to image data to be displayed by each mobile shop vehicle. Accordingly, in the present aspect, the each of the plurality of mobile shop vehicles may include an image registration unit configured to register the image data that is associated with the display type, and the image registration unit may be further configured to receive the image data corresponding to the display type, to determine whether or not the image data meets a criterion determined with respect to the display type, and to store the image data in the storage in association with the display type, in a case where the image data meets the criterion.

This allows only image data that meets the criterion according to the display type to be stored in the storage. That is, only images that meet the criterion are displayed on the outside display device, and the sense of unity as a whole may be maintained.

Alternatively or additionally, in the present aspect, the each of the plurality of mobile shop vehicles may include an image registration unit configured to register the image data that is associated with the display type, and the image registration unit may be further configured to receive image the data corresponding to the display type, to transmit the image data to a determination device configured to determine whether or not the image data meets a criterion determined with respect to the display type, and to store the image data in the storage in association with the display type, in a case where a determination result that the image data meets the criterion is acquired from the determination device. The determination device may be the same device as the server device, or may be a different device.

In this manner, the same effect as that described above may be obtained, also by using an external determination device and by determining whether or not image data meets a criterion.

In the present aspect, the image display instruction may include image data to be displayed on the outside display device or a source of the image data, and the display controller may be further configured to display, on the outside display device, the image data included in the image display instruction or image data acquired from the source of the image data.

In this manner, by the server device instructing the mobile shop vehicles about which images to display, the sense of unity as a whole may be maintained.

In the present aspect, the each of the plurality of mobile shop vehicles may further include a position information acquisition unit configured to acquire position information, and a transmitter configured to transmit the position information to the server device, and the server device may further include a receiver configured to receive the position information from the mobile shop vehicle, and an image determination unit configured to determine image data to be displayed on the outside display device of the mobile shop vehicle, according to the position information of the mobile shop vehicle.

In this manner, by determining the image to be displayed, according to the position of a mobile shop vehicle, for example, the plurality of mobile shop vehicles may, as a whole, display one image. Even if the arrangement of the mobile shop vehicles is changed, an appropriate image may be displayed.

In the present aspect, the each of the plurality of mobile shop vehicles may further include an inside display that is provided inside the vehicle body, and the image display instruction may instruct of an image to be displayed on the inside display.

The server device may thereby control not only the appearance of the mobile shop vehicle, but also how the inside looks like.

The present disclosure may be specified as a mobile shop system including at least one of the units described above. The present disclosure may also be specified as a control method for performing the processes described above, a program for causing a computer to perform the control method, or a non-transitory computer-readable medium storing the program. The processes and units described above may be freely combined to the extent that no technical conflict exists.

According to the present disclosure, a sense of unity may be maintained in terms of appearance of a shopping mall made up of a plurality of mobile shop vehicles.

### BRIEF DESCRIPTION OF THE DRAWINGS

FIG. 1A is a system overview of a mobile shop system according to a first embodiment, and FIG. 1B is an external view of a mobile shop vehicle according to the first embodiment;

FIG. 2 is a functional block diagram of the mobile shop system according to the first embodiment;

FIG. 3 is a diagram describing a flow of an image data registration process of the mobile shop system according to the first embodiment;

FIG. 4 is a diagram describing an example of an image data storage unit according to the first embodiment;

FIG. 5 is a diagram describing a flow of an image display process of the mobile shop system according to the first embodiment;

FIG. 6 is a diagram describing a flow of an image data registration process according to an example modification of the first embodiment;

FIG. 7 is a functional block diagram of a mobile shop system according to a second embodiment;

FIG. 8 is a diagram describing a flow of an image display process of the mobile shop system according to the second embodiment; and

FIG. 9A is a diagram describing an example of an image data storage unit according to the second embodiment, and FIG. 9B is a diagram describing a display area according to the second embodiment.

### DESCRIPTION OF THE EMBODIMENTS

### First Embodiment

### (System Overview)

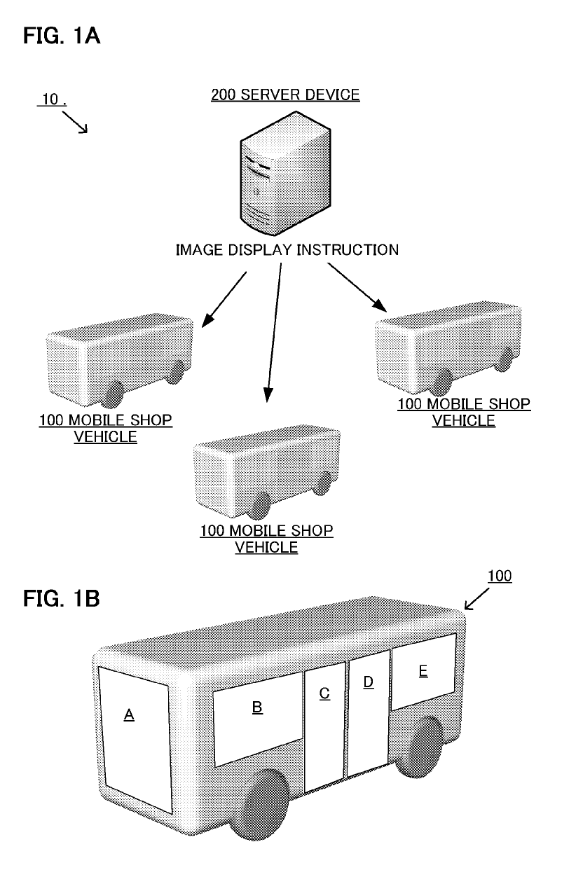

A present embodiment is a system for providing shop guide information in a shopping mall (shopping complex) formed by a plurality of mobile shop vehicles which are gathered together. In the following, a mobile shop system 10 according to the present embodiment will be described with reference to FIGS. 1A and 1B. The mobile shop system 10 according to the present embodiment includes a plurality of mobile shop vehicles 100, and a server device 200.

The mobile shop vehicles 100 are multipurpose mobile bodies which are each capable of having a function different from that of another, and are, in the present embodiment, vehicles which are capable of traveling on a road. The mobile shop vehicle 100 includes, inside the vehicle, facility/equipment for operating a shop, and may operate a business by traveling to a destination and spreading out the facility/equipment. In the present disclosure, a “shop” refers to a facility for providing products (objects) or services for profit or for free.

In the present embodiment, the plurality of mobile shop vehicles 100 each include a display on an outside of the vehicle body. Parts indicated by A to E in FIG. 1B are displays. Accordingly, the mobile shop vehicle 100 may change the appearance by changing images displayed on the displays.

Here, if the mobile shop vehicles 100 separately determine the images to be displayed on the displays, the sense of unity in the overall appearance of the shopping mall is possibly lost. In the present embodiment, the mobile shop vehicles 100 display images on the displays according to an instruction from the server device 200 to thereby maintain the sense of unity of the entire shopping mall.

(System Configuration)

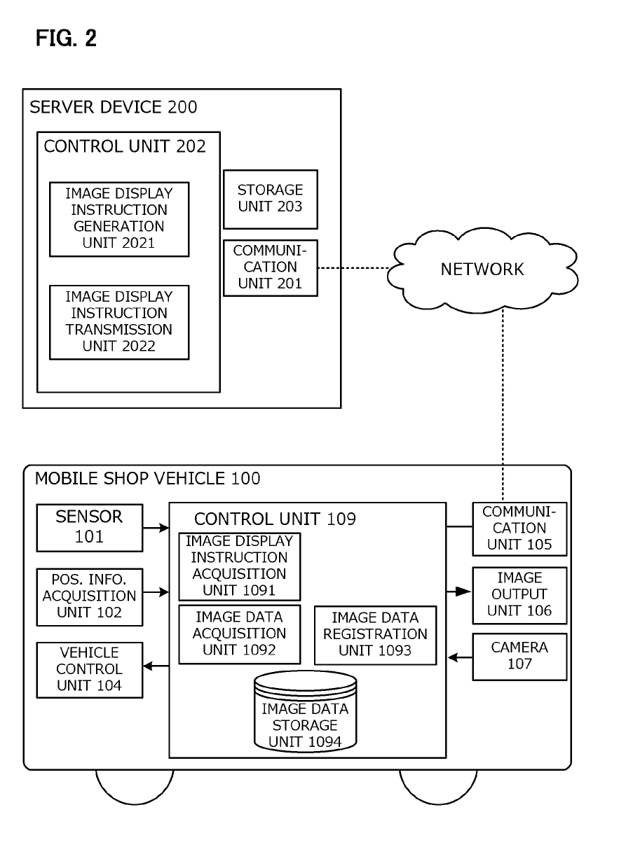

Constituent elements of the system will be described in detail. FIG. 2 is a block diagram schematically illustrating an example configuration of the mobile shop vehicle 100 and the server device 200 illustrated in FIGS. 1A and 1B.

(Mobile Shop Vehicle 100)

The mobile shop vehicle 100 includes, inside the vehicle, equipment for operating a shop, but in the present specification, a description of the equipment for operating a shop is omitted. A description is given here mainly of a function of a vehicle and a function for displaying an image on an outside display, both of which are common function for the plurality of mobile shop vehicles 100.

The mobile shop vehicle 100 includes a sensor 101, a position information acquisition unit 102, a vehicle control unit 104, a communication unit 105, an image output unit 106, a camera 107, and a control unit 109. The mobile shop vehicle 100 may be a gasoline vehicle, a diesel vehicle or an electric vehicle, and is driven by an internal-combustion engine or by power supplied from a battery.

The sensor 101 senses a state of the vehicle, or that senses the surroundings of the vehicle. As the sensor 101 for sensing the state of the vehicle, an accelerometer, a speed sensor or an azimuth sensor may be cited. As the sensor 101 for sensing the surroundings of the vehicle, a stereo camera, a laser scanner, a LIDAR, a radar or the like may be cited. Information acquired by the sensor 101 is transmitted to the control unit 109.

The position information acquisition unit 102 acquires a current position of the vehicle, and is typically a global positioning system (GPS) device that receives a GPS satellite signal and that obtains position information. The position information obtained from the GPS device indicates latitude, longitude and altitude. The position information acquisition unit 102 may be a positioning device according to a global navigation satellite system (GNSS) instead of the GPS, or a positioning device adopting base station positioning, so long as the current position of the vehicle may be acquired.

The vehicle control unit 104 controls functions, of the mobile shop vehicle 100, as the vehicle. For example, the vehicle control unit 104 includes an engine or a motor and an inverter, a brake, steering, and an electronic control unit (ECU) that controls these parts.

The communication unit 105 connects the mobile shop vehicle 100 to a network. In the present embodiment, communication with other devices (such as the server device 200) may be performed over the network by using a mobile communication service such as 3G or LTE. Additionally, the communication unit 105 may also include communication units for performing inter-vehicle communication with other mobile shop vehicles 100.

The image output unit 106 outputs an image to an outside display (outside display device) provided on the vehicle body. The mobile shop vehicle 100 according to the present embodiment includes a display on the outside of the vehicle body, and is capable of outputting an arbitrary image. The outside display may be a liquid crystal display, an organic EL display, or an LED matrix, for example.

The camera 107 is a camera provided on the vehicle body of the mobile shop vehicle 100. In the present embodiment, the mobile shop vehicle 100 includes an in-vehicle camera 107, and is capable of acquiring an image (still image or moving image). The number of cameras 107 is not particularly specified as long as it is at least one. A plurality of cameras may be installed such that capturing may be performed with respect to the front, rear, left and right.

The control unit 109 is a computer that controls the entire mobile shop vehicle 100. For example, the control unit 109 includes a microprocessor and a memory storing programs, and functions as an image display instruction acquisition unit 1091, an image data acquisition unit 1092, an image data registration unit 1093, and an image data storage unit 1094, when the microprocessor executes the programs. Details of these functional units will be described together with a flowchart. Additionally, a part or all of the functions may be achieved by a logic circuit such as an application specific integrated circuit (ASIC) or a field programmable gate array (FPGA).

(Server Device 200)

Next, the server device 200 will be described. The server device 200 issues an instruction to the plurality of mobile shop vehicles 100 as to what kind of image is to be displayed on the outside displays.

The server device 200 includes a communication unit 201, a control unit 202, and a storage unit 203.

Like the communication unit 105, the communication unit 201 is a communication interface for performing communication with the mobile shop vehicle 100 over the network.

The control unit 202 is in charge of control of the server device 200. For example, the control unit 202 includes a microprocessor and a memory storing programs, and functions as an image display instruction generation unit 2021 and an image display instruction transmission unit 2022, when the microprocessor executes the programs. Additionally, a part or all of the functions may be achieved by a logic circuit such as an ASIC or an FPGA.

The image display instruction generation unit 2021 generates an image display instruction for the mobile shop vehicle. Specifically, a display type regarding image display is acquired from an operator, and an image display instruction indicating that image display is to be performed according to the display type is generated. The display type is an arbitrary criterion for categorizing images, and may be Halloween, Christmas or New Year's, for example.

The image display instruction transmission unit 2022 simultaneously transmits the generated image display instruction to the mobile shop vehicles 100 through the communication unit 201.

The storage unit 203 stores information, and is a storage medium such as a RAM, a magnetic disk, a semiconductor memory or the like.

(Processes)

Processes of the present embodiment may be roughly divided into two processes of an image data registration process at the mobile shop vehicle 100, and an image display process according to an instruction from the server device 200. In the following, the processes will be described in this order.

(Image Data Registration Process)

In the present embodiment, an instruction indicating which display type is adopted for image display is issued by the server device 200, and the mobile shop vehicle 100 reads image data that is registered in the image data storage unit 1094 in association with the display type, and outputs the image data to the image output unit (outside display) 106. Accordingly, the mobile shop vehicle 100 has to have pieces of image data registered in advance in association with display types. Additionally, the image data may be still images or moving images.

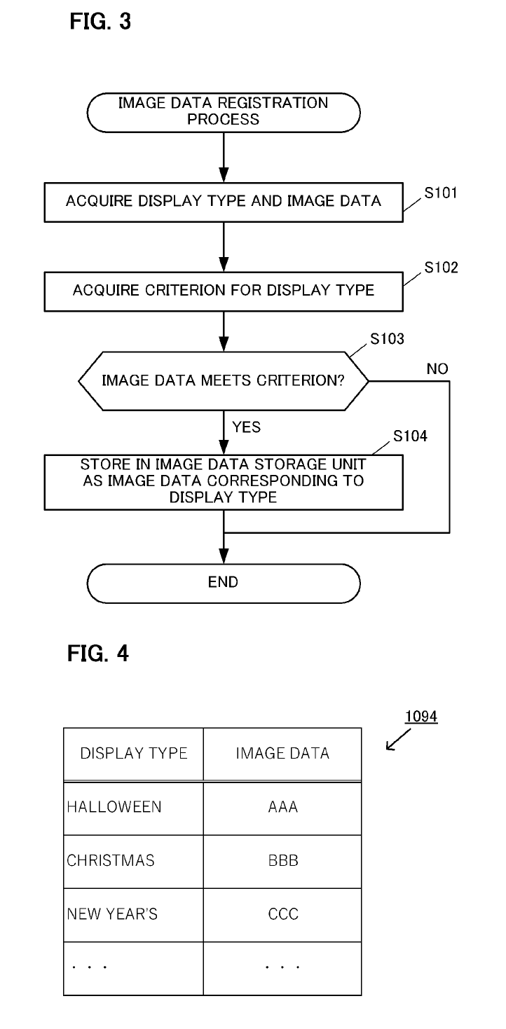

In the following, the image data registration process of the present embodiment will be described with reference to FIG. 3.

In step S101, the image data registration unit 1093 acquires a display type and image data from a user. For example, the image data registration unit 1093 receives input of image data corresponding to a display type “Christmas”.

In step S102, the image data registration unit 1093 acquires a criterion the image data of the display type acquired in step S101 is to meet. The criterion may be stored in advance in the mobile shop vehicle 100, or may be acquired from the server device 200 or another device as appropriate.

In step S103, the image data registration unit 1093 determines whether or not the image data acquired in step S101 meets the criterion acquired in step S102. In the case where the image data meets the criterion (S103: YES), the image data registration unit 1093 stores the image data in the image data storage unit 1094 as image data corresponding to the display type in step S104. In the case where the image data does not meet the criterion (S103: NO), the image data is not registered. At this time, a notification is issued as to which criterion item is not met.

The criterion related to the display type may be any criterion as long as a sense of unity in appearance may be achieved between pieces of image data meeting the criterion. For example, a criterion regarding a color combination may be adopted. For example, the display type “Christmas” may adopt a criterion that red, green and white have to account for at least a predetermined percentage (such as 90%) of the whole. The criterion may be the type of an object included in an image. For example, the display type “Christmas” may adopt a criterion that objects related to Santa Claus, reindeer, a Christmas tree, winter and the like have to account for at least a predetermined percentage of the whole. Furthermore, the criterion may be given in the form of a classifier which is obtained as a result of machine learning. For example, in the case of the display type “Christmas”, a classifier that calculates a Christmas-like degree of an image may be used, and the criterion may be determined to be met if an output of the classifier is at or higher than a threshold (such as 0.9).

By adopting such a registration process, appropriate image data alone which is according to the display type is registered. FIG. 4 is a diagram describing an example of the image data storage unit 1094. In the example, image data is stored in the image data storage unit 1094 in association with each of display types “Halloween”, “Christmas” and “New Year's”. Additionally, the display types are not limited to the events mentioned, and may be any event.

(Image Display Process)

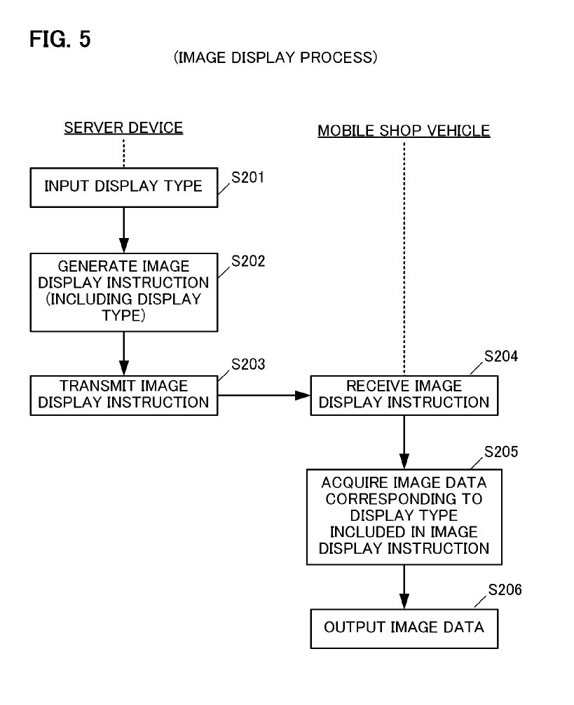

Next, the image display process of the mobile shop system according to the present embodiment will be described with reference to FIG. 5.

In step S201, the server device 200 receives, from an operator, an input regarding which display type is to be adopted to perform image display. In step S202, the image display instruction generation unit 2021 generates an image display instruction including the display type. In step S203, the image display instruction transmission unit 2022 simultaneously transmits the image display instruction to the mobile shop vehicles 100 through the communication unit 201.

In step S204, the image display instruction acquisition unit 1091 of the mobile shop vehicle 100 receives the image display instruction from the server device 200. In step S205, the image data acquisition unit 1092 acquires, from the image data storage unit 1094, image data that is associated with the display type included in the image display instruction. In step S206, the control unit 109 outputs the acquired image data to the image output unit (outside display) 106.

### Effect

According to the present embodiment, a plurality of mobile shop vehicles 100 display, on the outside displays, images with a sense of unity, according to an instruction from the server device 200. A sense of unity may thereby be achieved in terms of the appearance of a shopping mall made up of a plurality of mobile shop vehicles 100.

### First Modification of First Embodiment

In the description above, a determination process of whether image data to be registered in association with a display type meets a criterion or not is performed within the mobile shop vehicle 100, but the determination process may alternatively be performed by an external device (determination device) other than the mobile shop vehicle 100. The determination device may be the same or different from the server device 200.

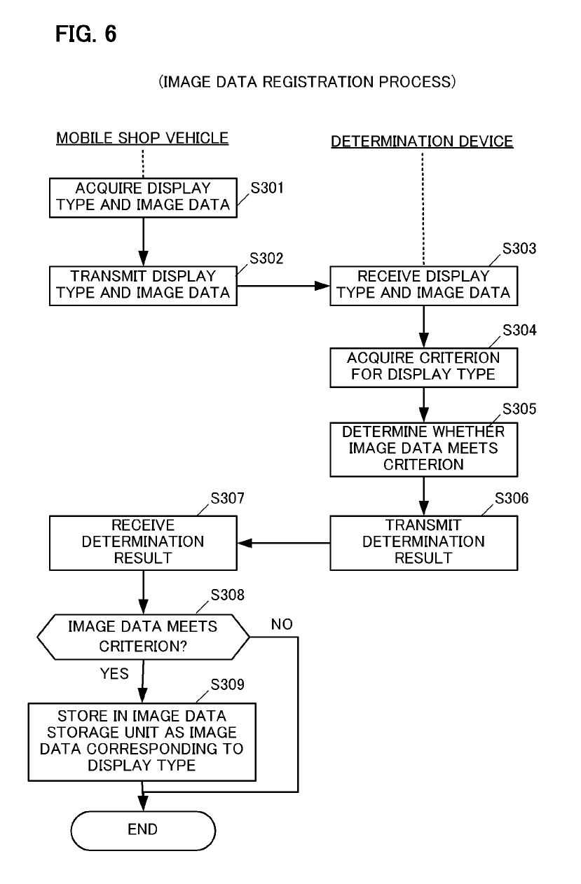

An image data registration process according to the present example modification will be described with reference to FIG. 6.

In step S301, the image data registration unit 1093 of the mobile shop vehicle 100 acquires a display type and image data from a user. In step S302, the mobile shop vehicle 100 transmits the display type and the image data to a determination device.

In step S303, the determination device receives the display type and the image data from the mobile shop vehicle 100. The determination device acquires a criterion corresponding to the display type in step S304, determines whether the image data meets the criterion or not in step S305, and transmits a determination result to the mobile shop vehicle 100 in step S306. The processes in steps S304 and S305 may be achieved in the same manner as in steps S102 and S103 in the first embodiment. Additionally, the determination process (S305) in the present embodiment may be manually performed by a person.

The mobile shop vehicle 100 receives the determination result in step S307, and in the case where the image data meets the criterion (S308: YES), the image data is stored in the image data storage unit 1094 as image data corresponding to the display type in step S309.

The same effect as that of the first embodiment is obtained by the present example modification.

### Second Modification of First Embodiment

In the description above, the image data is registered in the image data storage unit 1094 by the image data registration process. However, other manners may also be adopted. For example, image data of each display type may be transmitted from the server device 200 to the mobile shop vehicles 100. An image transmitted from the server device 200 is thereby displayed, and the sense of unity as one shopping mall may be maintained.

Alternatively, a template of image data may be transmitted from the server device 200, and a user of the mobile shop vehicle 100 may change a part of the template and store the changed template in the image data storage unit 1094. By using such a template, the sense of unity may be achieved in terms of entire appearance while enabling display of an image which is customized for each mobile shop vehicle 100.

### Second Embodiment

A present embodiment is an embodiment in which the server device 200 instructs the mobile shop vehicle 100 as to which image data is to be displayed.

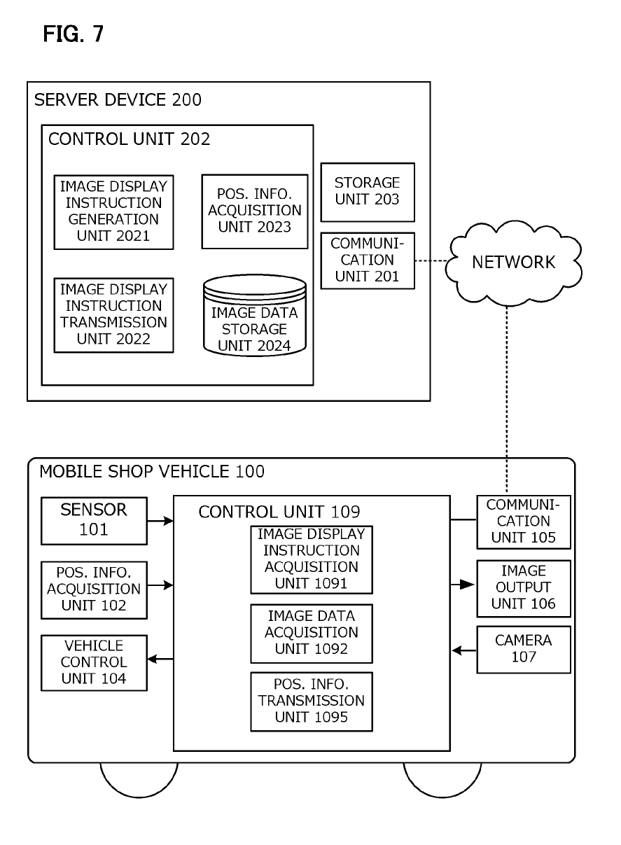

FIG. 7 is a block diagram schematically illustrating an example configuration of the mobile shop vehicle 100 and the server device 200 according to the present embodiment. The configuration of the present embodiment is basically the same as the configuration of the first embodiment, but functions of the control unit 109 of the mobile shop vehicle 100 and the control unit 202 of the server device 200 are different from those of the first embodiment. The control unit 109 of the mobile shop vehicle 100 includes the image display instruction acquisition unit 1091, the image data acquisition unit 1092, and a position information transmission unit 1095. The control unit 202 of the server device 200 includes the image display instruction generation unit 2021, the image display instruction transmission unit 2022, a position information acquisition unit 2023, and an image data storage unit 2024.

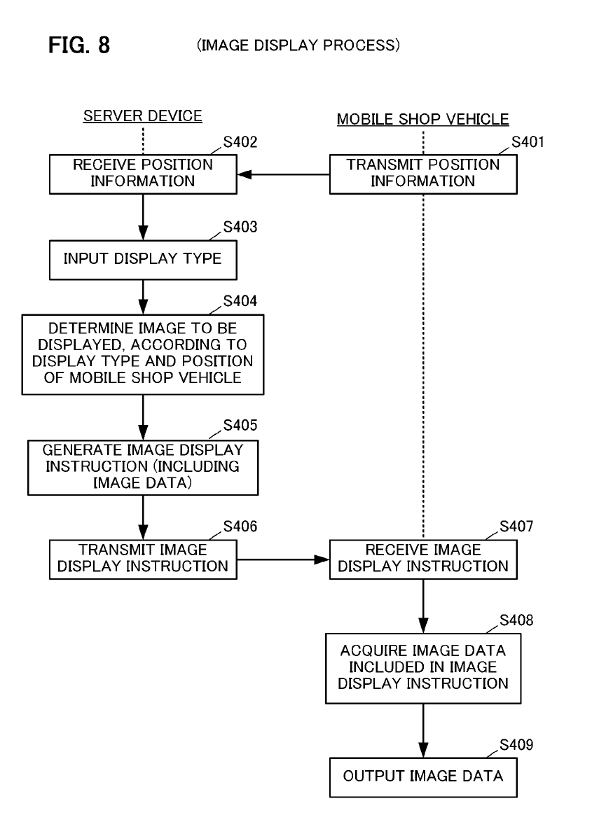

In the following, the present embodiment will be described with reference to the flowchart in FIG. 8.

In step S401, the mobile shop vehicle 100 acquires position information from the position information acquisition unit 102, and transmits the position information to the server device 200 through the communication unit 105. In step S402, the control unit 202 of the server device 200 receives the position information of the mobile shop vehicle 100, and stores the position information in association with an identifier of the mobile shop vehicle. Additionally, transmission of the position information may be performed regularly by all the mobile shop vehicles 100, or may be performed merely when the position is changed, or may be performed merely at a timing when an instruction regarding image display is issued by the server device 200,

In step S403, the server device 200 receives, from an operator, an input regarding which display type is to be adopted to perform image display. In step S404, the image display instruction generation unit 2021 determines an image that a mobile shop vehicle 100 is to display, according to the display type and the position of the mobile shop vehicle 100.

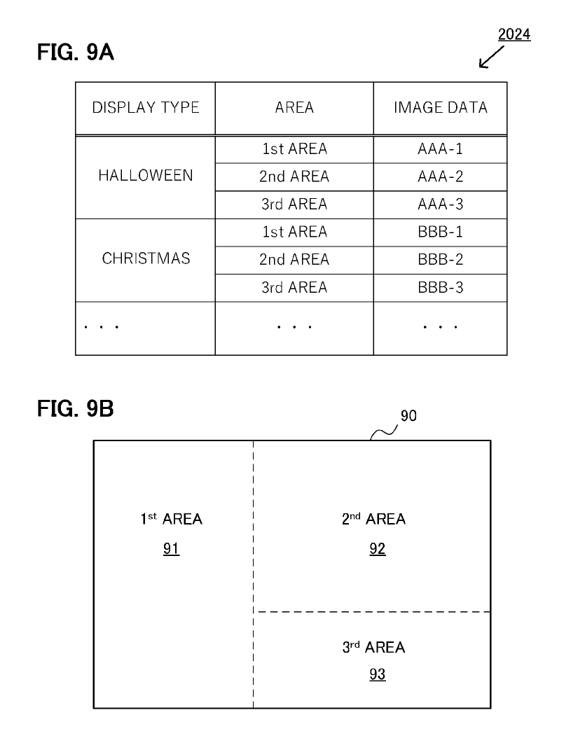

A description will now be given of the image data storage unit 2024 according to the present embodiment. Image data to be displayed is stored in the image data storage unit 2024 for each display type and for each position (see FIG. 9A). As illustrated in FIG. 9B, “area” in FIG. 9A is an area obtained by dividing an entire area 90 of the shopping mall. In this case, the entire area 90 is divided into first to third areas 91 to 93, but the number of divisions of the area is not particularly limited. A method of dividing (setting) an area may be changed for each display type.

As described above, image data to be displayed is stored in the image data storage unit 2024, for each display type and for each position, and thus, the image display instruction generation unit 2021 may determine the image data a mobile shop vehicle 100 is to display, according to the display type and the position of the mobile shop vehicle 100.

In step S405, the image display instruction generation unit 2021 generates an image display instruction including the image data. In step S406, the image display instruction transmission unit 2022 transmits the image display instruction to the mobile shop vehicle 100 through the communication unit 201. Additionally, in the present embodiment, the image display instruction is generated for each mobile shop vehicle 100. However, one image display instruction may include instructions for a plurality of mobile shop vehicles 100. Particularly, instructions for mobile shop vehicles 100 which are to display the same image data may be made into one instruction.

In step S407, the image display instruction acquisition unit 1091 of the mobile shop vehicle 100 receives the image display instruction from the server device 200. In step S408, the image data acquisition unit 1092 acquires the image data included in the image display instruction. In step S409, the control unit 109 outputs the acquired image data to the image output unit (outside display) 106.

According to the present embodiment, an image to be displayed on the outside display by the mobile shop vehicle 100 may be controlled according to an instruction from the server device 200, and the sense of unity may be achieved in terms of the overall appearance of the shopping mall. Image data to be displayed is also changed according to the position of the mobile shop vehicle 100, and thus, even in a case where the mobile shop vehicle 100 is moved, the sense of unity of images may be maintained in each area.

### First Modification of Second Embodiment

In the second embodiment, image data itself is transmitted from the server device 200 to the mobile shop vehicle 100, but image data itself does not always have to be transmitted from the server device 200. An image display instruction, which is generated by the image display instruction generation unit 2021, may include a data source (such as a universal resource locator (URL)) of image data which is to be displayed. The mobile shop vehicle 100 may acquire image data from the data source included in the image display instruction, and perform display.

### Second Modification of Second Embodiment

In the description above, the server device 200 includes the image data storage unit 2024 storing image data for each display type and for each position, but other manners may also be adopted. For example, the server device 200 may store, for each display type, one piece of image data corresponding to the entire area, and generate an image display instruction such that a part, of the image data, corresponding to the position of the mobile shop vehicle 100 is displayed at the mobile shop vehicle 100. This enables one image to be constructed by the entire shopping mall.

### Third Modification of Second Embodiment

An effect the same as that of the second embodiment may be achieved by a configuration similar to that of the first embodiment. For example, as in the first embodiment, the server device 200 issues, to the mobile shop vehicle 100, an instruction regarding the display type alone. The mobile shop vehicle 100 may include a storage unit the same as the image data storage unit 2024, and acquire image data to be displayed, based on the display type in the instruction from the server device 200 and the position information acquired from the position information acquisition unit 102. The same effect as that of the second embodiment may thus be obtained.

In the present example modification, the image data which is stored in the mobile shop vehicle 100 may be image data which is transmitted in advance from the server device 200, or may be image data which is registered in advance by a registration process the same as that of the first embodiment.

### Other Embodiments

In the description above, a process is described by which an image to be displayed on the outside display of the mobile shop vehicle 100 is determined according to an instruction from the server device 200, but not all the images have to be determined in this manner. For example, the mobile shop vehicle 100 may freely determine a display image with respect to one or some of displays among the outside displays. Alternatively, time-based switching may be performed between display according to an instruction from the server device 200 and free display. For example, the mobile shop vehicle 100 may be allowed to freely determine a display image in a time slot when no image display instruction is transmitted from the server device 200.

In the description above, a description is given of an image alone which is displayed on the outside display of the mobile shop vehicle 100, but an image which is displayed on an inside display of the mobile shop vehicle 100 may also be determined in the same manner according to an instruction from the server device 200.

In the description above, an image is displayed on the outside display of the mobile shop vehicle 100, and a color or brightness of illumination may be controlled according to an instruction from the server device. That is, the outside display device of the present disclosure may be an illumination device.

The embodiments described above are merely examples, and a plurality of embodiments may be combined, or a modification may be made as appropriate within the scope of the present disclosure. For example, a process which is described to be performed by one device may be divided and performed by a plurality of devices. A process which is described to be performed by different devices may be performed by one device. Which hardware component (server component) in a computer system is to achieve each function may be flexibly changed.

What is claimed is:

1. A mobile shop system including a plurality of mobile shop vehicles and a server device, wherein
the server device includes an instruction unit configured to transmit an image display instruction indicative of an image to be displayed on an outside display device, to the plurality of mobile shop vehicles, and
each of the plurality of mobile shop vehicles includes
the outside display device provided on an outside of a vehicle body,
a receiver configured to receive the image display instruction from the server device, and
a display controller configured to control display contents of the outside display device according to the image display instruction.

2. The mobile shop system according to claim 1, wherein
the each of the plurality of mobile shop vehicles further includes a storage configured to store image data in association with a display type determined in advance,
the image display instruction includes the display type of an image to be displayed on the outside display device, and
the display controller is further configured to acquire, from the storage, the image data that is associated with the display type included in the image display instruction, and to perform display on the outside display device.

3. The mobile shop system according to claim 2, wherein
the each of the plurality of mobile shop vehicles includes an image registration unit configured to register the image data that is associated with the display type, and
the image registration unit is further configured
to receive the image data corresponding to the display type,
to determine whether or not the image data meets a criterion determined with respect to the display type, and
to store the image data in the storage in association with the display type, in a case where the image data meets the criterion.

4. The mobile shop system according to claim 2, wherein
the each of the plurality of mobile shop vehicles includes an image registration unit configured to register the image data that is associated with the display type, and
the image registration unit is further configured
to receive the image data corresponding to the display type,
to transmit the image data to a determination device configured to determine whether or not the image data meets a criterion determined with respect to the display type, and
to store the image data in the storage in association with the display type, in a case where a determination result that the image data meets the criterion is acquired from the determination device.

5. The mobile shop system according to claim 1, wherein
the image display instruction includes image data to be displayed on the outside display device or a source of the image data, and
the display controller is further configured to display, on the outside display device, the image data included in the image display instruction or image data acquired from the source of the image data.

6. The mobile shop system according to claim 5, wherein
the each of the plurality of mobile shop vehicles further includes
a position information acquisition unit configured to acquire position information, and
a transmitter configured to transmit the position information to the server device, and
the server device further includes
a receiver configured to receive the position information from the mobile shop vehicle, and
an image determination unit configured to determine image data to be displayed on the outside display device of the mobile shop vehicle, according to the position information of the mobile shop vehicle.

7. A control method of a mobile shop system including a plurality of mobile shop vehicles, each including an outside display device provided on an outside of a vehicle body, and a server device, the control method comprising:
an instructing step performed by the server device to transmit an image display instruction indicative of an image to be displayed on the outside display device, to the plurality of mobile shop vehicles;
a receiving step performed by each of the plurality of mobile shop vehicles to receive the image display instruction from the server device; and
a display controlling step performed by the each of the plurality of mobile shop vehicles to control display contents of the outside display device according to the image display instruction.

8. A non-transitory computer-readable medium storing a program for causing a computer to execute:
an instructing step performed by a server device to transmit an image display instruction indicative of an image to be displayed on an outside display device, to a plurality of mobile shop vehicles;
a receiving step performed by each of the plurality of mobile shop vehicles to receive the image display instruction from the server device; and
a display controlling step performed by the each of the plurality of mobile shop vehicles to control display contents of the outside display device according to the image display instruction.
